(19) United States
(12) Patent Application Publication
(10) Pub. No.: US 2026/0077607 A1
(43) Pub. Date: Mar. 19, 2026

(54) RECORDING DEVICE

(71) Applicant: SEIKO EPSON CORPORATION, Tokyo (JP)

(72) Inventors: Daisuke FUJIWARA, MATSUMOTO-SHI (JP); Masaki KOBAYASHI, MATSUMOTO-SHI (JP)

(21) Appl. No.: 19/324,425

(22) Filed: Sep. 10, 2025

(30) Foreign Application Priority Data
Sep. 13, 2024 (JP) 2024-158963

(51) Int. Cl. B41J 15/04; B41J 11/00; B41J 15/16

(52) U.S. Cl. CPC B41J 15/046; B41J 11/0005; B41J 11/0021; B41J 15/048; B41J 15/165

(57) ABSTRACT

A recording device includes a conveyance unit that conveys a medium, a recording unit that performs recording on the medium, a take-up roller that winds up the medium, a tension roller between the conveyance unit and the take-up roller in a conveyance path of the medium, and that applies tension to the medium, an intermediate guide member between the take-up roller and the tension roller and on which the medium is wound in a direction such that a surface opposite to the recording surface is in contact with an outer surface thereof, a first heating unit that heats the intermediate guide member, and a downstream guide roller that is rotatably disposed between the take-up roller and the intermediate guide member in the conveyance path and on which the medium is wound in a direction such that the recording surface is in contact with an outer surface thereof.

The present application is based on, and claims priority from JP Application Serial Number 2024-158963, filed Sep. 13, 2024, the disclosure of which is hereby incorporated by reference herein in its entirety.

### BACKGROUND

### 1. Technical Field

The present disclosure relates to a recording device.

### 2. Related Art

JP-A-2023-22374 discloses a printing device including a conveyance unit, a printing unit, a take-up unit, a tension applying unit, and a take-up guide member. The conveyance unit conveys a medium in a conveyance direction. The printing unit performs printing on the medium conveyed by the conveyance unit. The take-up unit winds up the medium conveyed by the conveyance unit. The tension applying unit presses the medium between the conveyance unit and the take-up unit and thus applies tension to the medium. The medium positioned between the tension applying unit and the take-up unit is wound on the take-up guide member. Thus, the take-up unit winds up the medium to which the tension is applied by the tension applying unit into a roll shape via the take-up guide member.

JP-A-2023-22374 is an example of the related art.

However, in the printing device of JP-A-2023-22374, when the outer diameter of the medium wound up in a roll shape changes, the wrap angle of the medium wound on the take-up guide member changes. When the wrap angle of the medium wound on the take-up guide member changes, the tension applied to the medium wound up by the take-up unit varies. When the tension applied to the medium wound up by the take-up unit varies, winding defects such as winding misalignment may occur in the medium wound in a roll shape.

### SUMMARY

According to an aspect of the present disclosure, a recording device includes: a conveyance unit configured to convey a medium; a recording unit configured to perform recording on a recording surface of the medium; a take-up unit configured to wind up the conveyed medium; a tension applying unit movably disposed at a position between the conveyance unit and the take-up unit in a conveyance path along which the medium is conveyed, the tension applying unit being configured to come into contact with the medium and thus apply tension to the medium; an intermediate guide member that is disposed at a position between the take-up unit and the tension applying unit in the conveyance path and on which the medium is wound in a direction such that a surface opposite to the recording surface is in contact with an outer surface thereof; a first heating unit configured to heat the intermediate guide member; and a downstream guide roller that is rotatably disposed at a position between the take-up unit and the intermediate guide member in the conveyance path and on which the medium is wound in a direction such that the recording surface is in contact with an outer surface thereof.

### BRIEF DESCRIPTION OF THE DRAWINGS

FIG. 1 is a schematic cross-sectional view showing a schematic configuration of a recording device according to an embodiment.

FIG. 2 is a functional block diagram of the recording device according to the embodiment.

FIG. 3 is a schematic cross-sectional view showing a configuration around a take-up device according to the embodiment.

### DESCRIPTION OF EMBODIMENTS

Hereinafter, the present disclosure will be described, based on embodiments. In the drawings, the same reference numerals are given to the same members, and repeated descriptions thereof will be omitted. The terms “same”, “identical”, and “simultaneous” used in the present specification are not limited to being completely the same.

For example, in the present specification, when the terms “same”, “identical”, and “simultaneous” are used, the meanings thereof include cases where things are the same in consideration of a measurement error. Also, for example, in the present specification, when the terms “same”, “identical”, and “simultaneous” are used, the meanings thereof include cases where things are the same in consideration of a manufacturing variation of the member.

In the present specification, when the terms “same”, “identical”, and “simultaneous” are used, the meanings thereof include cases where things are the same without impairing functions. Therefore, for example, “the dimensions of two members are the same” means that a dimensional difference between the two members is within ±5% of the dimension of one member, particularly preferably within ±3%, in consideration of a measurement error and a manufacturing variation of the members.

In the drawings, X, Y, and Z represent three spatial axes orthogonal to each other. In the present specification, directions along these axes are referred to as an X-axis direction, a Y-axis direction, and a Z-axis direction. To specify which side along a direction is indicated, a positive or negative sign is added to the indication of the direction, where “+” refers to a positive direction and “−” refers to a negative direction, and a direction indicated by an arrow in each drawing is referred to as a + direction and a direction opposite to the arrow is referred to as a − direction.

The Z-axis direction represents the direction of gravity, the +Z direction represents a vertically upward direction, and the −Z direction represents a vertically downward direction. A plane including the X axis and the Y axis is described as an X-Y plane, a plane including the X axis and the Z axis is described as an X-Z plane, and a plane including the Y axis and the Z axis is described as a Y-Z plane. The X-Y plane is a horizontal plane. The three spatial axes X, Y, and Z on which the positive direction and the negative direction are not limited are described as the X axis, the Y axis, and the Z axis.

The X-axis direction is a horizontal direction along an installation surface, which is a horizontal surface where a recording device 1 is installed. The X-axis direction is the width direction of the recording device 1. The Y-axis direction is a horizontal direction along the installation surface where the recording device 1 is installed. The Y-axis direction is the depth direction of the recording device 1 and is the width direction of a medium M conveyed in the recording device 1.

The Z-axis direction is a normal direction to the installation surface where the recording device 1 is installed, and is the height direction of the recording device 1. In the description below, the +Z direction may be referred to as “vertically above” and the −Z direction may be referred to as “vertically below”.

In the description below, in the recording device 1, the forward side in a conveyance direction of the medium M may be referred to as “downstream”, and the backward side in the conveyance direction may be referred to as “upstream”. For the sake of convenience of illustration, the size of each member may be different from the actual size.

A schematic configuration of the recording device 1 according to an embodiment will now be described. In the present embodiment, the recording device 1 is configured as an inkjet printer, and ejects ink onto the long medium M and thus forms an image thereon. The ink is an example of a liquid.

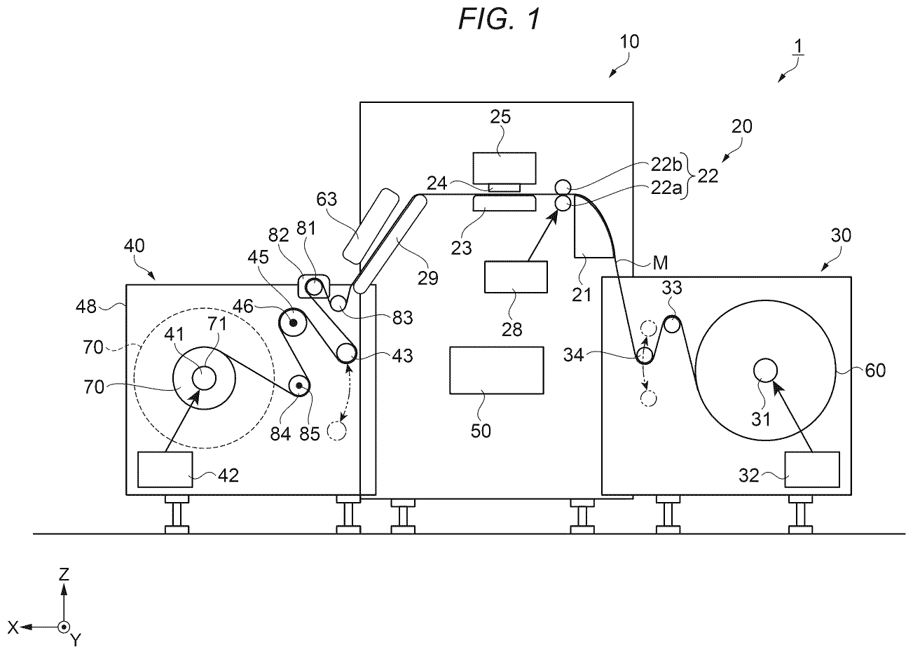

As illustrated in FIG. 1, the recording device 1 includes a device main body 10, a supply device 30, and a take-up device 40. The device main body 10 includes a control unit 50, a conveyance unit 20, a recording unit 24, a carriage 25, and a drying unit 63.

The supply device 30 feeds the medium M toward the device main body 10. The take-up device 40 winds up the conveyed medium M.

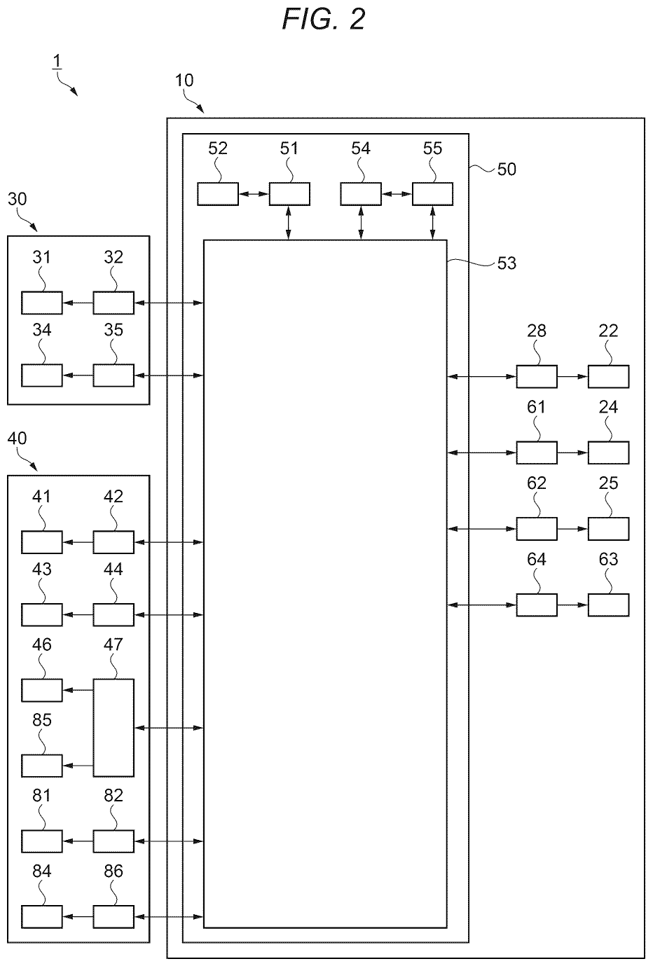

The control unit 50 controls each unit provided in the recording device 1. The control of each unit provided in the recording device 1 by the control unit 50 includes, for example, conveyance control of the medium M by the conveyance unit 20, recording control on the medium M by the recording unit 24, and the like. The control unit 50 includes a control unit 51 (see FIG. 2) that controls the operation of each unit provided in the recording device 1.

For example, the control unit 51 controls the conveyance unit 20 and the recording unit 24, based on recording data acquired from an external computer or the like, not illustrated, and thus executes recording on the medium M. The control unit 50 may be configured with a plurality of units. Details of the control unit 50 will be described later.

The conveyance unit 20 conveys the medium M. The conveyance unit 20 includes a supply guide frame 21, a conveyance roller pair 22, a medium support unit 23, a conveyance roller drive unit 28, and a discharge guide frame 29.

The supply guide frame 21 guides the medium M fed from the supply device 30 to the conveyance roller pair 22. The supply guide frame 21 guides the medium M in an oblique direction having a +X component and a +Z component. The supply guide frame 21 may be configured with one member or a plurality of members.

The conveyance roller pair 22 includes a first conveyance roller 22a and a second conveyance roller 22b, and conveys the medium M. The first conveyance roller 22a is disposed in the −Z direction in relation to the medium M, and the second conveyance roller 22b is disposed in the +Z direction in relation to the medium M.

One of the first conveyance roller 22a and the second conveyance roller 22b is rotationally driven by a driving force from the conveyance roller drive unit 28. The first conveyance roller 22a and the second conveyance roller 22b are pressed against each other and thus hold the medium M therebetween.

When one of the first conveyance roller 22a and the second conveyance roller 22b is rotationally driven in the state of holding the medium M therebetween, the medium M is conveyed in the +X direction, in which the recording unit 24 is located.

The medium support unit 23 is provided at a position on the −Z direction side in relation to the recording unit 24. The medium support unit 23 is a flat plate-shaped member that supports the medium M conveyed by the conveyance roller pair 22.

A suction fan may be provided at a position on the −Z direction side in relation to the medium support unit 23. In this case, the medium support unit 23 is provided with a through hole through which an airflow circulates, and the medium M is drawn to the medium support unit 23 by the airflow of the suction fan.

The recording unit 24 forms, that is, records an image on a recording surface, which is a surface in the +Z direction of the medium M supported by the medium support unit 23. The recording unit 24 in the present embodiment is an inkjet head in which a plurality of nozzles are formed. The recording unit 24 ejects ink from the nozzles onto the medium M, based on a drive signal output from a recording unit drive unit 61 (see FIG. 2), and thus forms an image on the recording surface of the medium M.

The carriage 25 supports the recording unit 24. The carriage 25 can move forward and backward along the Y axis by being driven by a carriage drive unit 62 (see FIG. 2). As the recording unit 24 ejects ink onto the medium M when the carriage 25 is moving on the medium M along the Y axis, an image is formed along the Y axis.

As the above-described operation in which an image is formed along the Y axis and the operation in which the conveyance unit 20 conveys the medium M in the +X direction by a predetermined amount are alternately repeated, an image is formed in a range along the X-axis direction and the Y-axis direction on the medium M.

The discharge guide frame 29 guides the medium M on which recording is performed by the recording unit 24, to the take-up device 40. The discharge guide frame 29 guides the medium M in an oblique direction having a +X component and a −Z component. The discharge guide frame 29 may be configured with one member or a plurality of members.

The drying unit 63 heats the medium M on the discharge guide frame 29 and thus promotes fixing of the ejected ink to the medium M. The drying unit 63 is provided at a position facing the discharge guide frame 29 with the medium M placed therebetween. The drying unit 63 includes, for example, a halogen heater. The control unit 51 controls a drying unit adjustment unit 64 (see FIG. 2) and thus adjusts the heating of the medium M by the drying unit 63.

The supply device 30 is disposed on the −X direction side of the device main body 10. The supply device 30 includes a supply roller 31, a supply roller drive unit 32, a supply guide member 33, and a supply bar member 34. A medium roll 60 formed by winding the long medium M in a roll shape is mounted in the supply device 30.

The supply roller 31 extends along the Y axis and supports the medium roll 60. The supply roller 31 is rotatable about a rotation axis along the Y axis. The supply roller 31 rotates clockwise when viewed from the +Y direction and thus feeds the medium M from the medium roll 60 toward the device main body 10. The supply roller 31 is rotatably supported by a frame or the like, not illustrated, that is disposed at an end part in the +Y direction and an end part in the −Y direction of the supply device 30.

The supply roller drive unit 32 rotates the supply roller 31 under the control of the control unit 51. The supply roller drive unit 32 includes a drive source such as a motor, not illustrated, a transmission mechanism that transmits a driving force from the drive source to the supply roller 31, and a control circuit that causes the drive source to operate based on a control signal from the control unit 51.

The supply guide member 33 is disposed in the +X direction of the supply roller 31 and extends along the Y axis, similarly to the supply roller 31. The medium M fed from the supply roller 31 is wound on the supply guide member 33. The medium M wound on the supply guide member 33 is conveyed in an oblique direction having the +X component and the −Z component.

The supply guide member 33 is in contact with the medium M directly or via a cover member, not illustrated. The supply guide member 33 is, for example, a cylindrical member. The supply guide member 33 is rotatably supported by the frame or the like, not illustrated, of the supply device 30, and rotates following the conveyance of the medium M.

The supply bar member 34 is disposed in the +X direction of the supply guide member 33 and extends along the Y axis, similarly to the supply roller 31. The medium M conveyed via the supply guide member 33 is wound on the supply bar member 34, and tension is applied to the medium M.

The medium M wound on the supply bar member 34 is conveyed in an oblique direction having the +X component and a +Z component toward the supply guide frame 21 guiding the medium M to the conveyance roller pair 22. The supply bar member 34 is in contact with the medium M directly or via a cover member, not illustrated.

The supply bar member 34 is swingable by being driven by a supply bar drive unit 35 (see FIG. 2), and the position thereof in the Z-axis direction is displaced. The tension applied to the medium M is adjusted by the swinging of the supply bar member 34. The supply bar member 34 may have any shape as long as tension can be applied to the medium M, but the shape is preferably a cylindrical shape.

The take-up device 40 is disposed on the +X direction side of the device main body 10. The take-up device 40 winds up the medium M conveyed downstream from the device main body 10. The take-up device 40 winds up the medium M on which recording is performed by the recording unit 24 in the device main body 10.

The take-up device 40 includes a take-up roller 41, a take-up roller drive unit 42, a tension roller 43, a tension roller drive unit 44 (see FIG. 2), an intermediate guide member 45, a first heating unit 46, and a heating unit adjustment unit 47. The take-up device 40 further includes an upstream guide member 81, a switching unit 82, an upstream guide roller 83, a downstream guide roller 84, a second heating unit 85, a displacement unit 86 (see FIG. 2), and a frame 48.

The take-up roller 41 winds up the conveyed medium M. The take-up roller 41 is a cylindrical roller extending along the Y axis. A roll core 71 around which the medium M is wound is mounted at the take-up roller 41. The take-up roller 41 is an example of a take-up unit that winds up the medium M.

The take-up roller 41 is rotatable around a rotation axis along the Y axis. The take-up roller 41 rotates counterclockwise when viewed from the +Y direction and thus winds up, around the roll core 71, the medium M on which recording is performed by the recording unit 24 in the device main body 10.

The medium M wound up around the roll core 71 becomes a roll-shaped medium roll 70, and the roll diameter of the medium roll 70, that is, the diameter thereof, increases as the winding progresses. The medium roll 70 indicated by a dashed line in FIG. 1 illustrates a state where the entire medium M is wound up.

The take-up roller 41 is rotatably supported by the frame 48 disposed at an end part in the +Y direction and an end part in the −Y direction of the take-up device 40. The medium M is not limited to being wound up around the roll core 71 and may be directly wound up around the take-up roller 41.

The take-up roller drive unit 42 rotates the take-up roller 41 under the control of the control unit 51. The control unit 51 controls the take-up roller drive unit 42 and thus causes the take-up roller 41 to wind up the medium M.

The take-up roller drive unit 42 includes a drive source such as a motor, not illustrated, a transmission mechanism that transmits a driving force from the drive source to the take-up roller 41, and a control circuit that causes the drive source to operate based on a control signal from the control unit 51.

The tension roller 43 is disposed at a position between the take-up roller 41 and the discharge guide frame 29 of the conveyance unit 20 in the conveyance path along which the medium M is conveyed. The tension roller 43 is a rod-shaped member which is disposed in the −X direction of the take-up roller 41 and whose outer surface in contact with the medium M extends in the Y-axis direction.

The tension roller 43 in the present embodiment is a cylindrical roller rotatable around a center axis along the Y axis. The shape of the tension roller 43 is not limited as long as the tension roller 43 can apply tension to the medium M, but the shape is preferably a cylindrical shape.

The medium M is wound on the tension roller 43 in a direction such that the outer surface thereof is in contact with the recording surface of the medium M. The outer surface of the tension roller 43 may be formed of a cover member that covers the tension roller 43.

The medium M wound on the tension roller 43 is conveyed in an oblique direction having the +X component and the +Z component toward the intermediate guide member 45 downstream in the conveyance direction. The tension roller 43 is an example of a tension applying unit that applies tension to the medium M by coming into contact with the medium M.

The tension roller 43 is supported, for example, by a support part (not shown) of the tension roller drive unit 44 (see FIG. 2) so as to be swingable about the rotation axis of the take-up roller 41. As the tension roller drive unit 44 is driven, the tension roller 43 swings and the position thereof in the Z-axis direction is thus displaced. The tension applied to the medium M is changed due to the displacement of the tension roller 43.

The tension roller drive unit 44 is driven and controlled by the control unit 51 and thus displaces the tension roller 43. The control unit 51 controls the tension roller drive unit 44 and thus adjusts the tension applied to the medium M.

The tension roller drive unit 44 includes a drive source such as a motor, not illustrated, a transmission mechanism that transmits a driving force from the drive source to the support part, and a control circuit that causes the drive source to operate based on a control signal from the control unit 51.

The intermediate guide member 45 is disposed at a position between the take-up roller 41 and the tension roller 43 in the conveyance path along which the medium M is conveyed. The intermediate guide member 45 is disposed in the +X direction of the tension roller 43 and in the −X direction of the take-up roller 41. The intermediate guide member 45 is disposed in the +Z direction of the take-up roller 41 and the tension roller 43.

The intermediate guide member 45 is a cylindrical member that is shaped using a metal material such as aluminum or SUS, and extends along the Y axis. The medium M passing over the tension roller 43 and yet to be wound up around the take-up roller 41 is wound on the intermediate guide member 45.

The medium M is wound on the intermediate guide member 45 in a direction such that the opposite surface of the medium M, which is the back surface of the recording surface, is in contact with the outer surface of the intermediate guide member 45. The medium M wound on the intermediate guide member 45 is conveyed in the −Z direction toward the downstream guide roller 84 downstream in the conveyance direction.

The two ends of the intermediate guide member 45 in the Y-axis direction are supported by the frame 48. The intermediate guide member 45 in the present embodiment is not rotatable, and the medium M wound on the intermediate guide member 45 is conveyed so as to slide on the outer surface of the intermediate guide member 45.

The first heating unit 46 heats the intermediate guide member 45. The first heating unit 46 is disposed inside the cylindrical intermediate guide member 45. The first heating unit 46 is a cylindrical heater having a diameter smaller than the inner diameter of the intermediate guide member 45, and extends along the Y axis inside the intermediate guide member 45.

The two ends of the first heating unit 46 in the Y-axis direction are supported by the frame 48. The first heating unit 46 generates heat under the control of the heating unit adjustment unit 47 (see FIG. 2) and heats the intermediate guide member 45. The control unit 51 controls the heating unit adjustment unit 47 and thus adjusts the heating of the intermediate guide member 45 by the first heating unit 46.

The medium M is heated by being wound on the intermediate guide member 45 heated by the first heating unit 46. Thus, when the medium M is wound up around the take-up roller 41, wrinkling in the medium M is suppressed.

The upstream guide member 81 is disposed at a position between the tension roller 43 and the discharge guide frame 29 of the conveyance unit 20 in the conveyance path along which the medium M is conveyed. The upstream guide member 81 is disposed in the +Z direction of the tension roller 43.

The upstream guide member 81 is a cylindrical member and extends along the Y axis. The medium M passing over the discharge guide frame 29 and yet to come into contact with the tension roller 43 is wound on the outer surface of the upstream guide member 81.

The load acting on the upstream guide member 81 when the medium M is wound thereon is smaller than the load acting on the tension roller 43 when the medium M is wound thereon. Therefore, the outer diameter of the outer surface of the upstream guide member 81 is set to be smaller than the outer diameter of the outer surface of the tension roller 43.

The medium M located at a position between the tension roller 43 and the conveyance unit 20 in the conveyance path is wound on the upstream guide member 81. Thus, of the tension applied to the medium M by the tension roller 43, the tension transmitted upstream in the conveyance direction from the tension roller 43 is attenuated.

The medium M is wound on the upstream guide member 81 in a direction such that the opposite surface of the recording surface, which is the back surface of the medium M, is in contact with the outer surface of the upstream guide member 81. The medium M wound on the upstream guide member 81 is conveyed in an oblique direction having a −X component and the −Z component toward the tension roller 43 downstream in the conveyance direction.

The two ends of the upstream guide member 81 in the Y-axis direction are supported by the frame 48 via the switching unit 82. The switching unit 82 can switch the upstream guide member 81 between a rotating state where the outer surface thereof is rotatable and a fixed state where the outer surface thereof is not rotatable.

The switching unit 82 includes, for example, a lock member (not illustrated) that restricts the rotation of the upstream guide member 81, a drive source that displaces the lock member, and a control circuit that causes the drive source to operate based on a control signal from the control unit 51. As the drive source, an actuator such as a motor or an electromagnetic solenoid can be adopted.

The control unit 51 controls the switching unit 82 and thus switches between the rotating state and the fixed state of the upstream guide member 81. The control unit 51 switches between the rotating state and the fixed state of the upstream guide member 81, based on the specifications of the medium M to be used. The specifications of the medium M are estimated from the type of the medium M used for recording.

For example, when the coefficient of friction between the medium M and the outer surface of the upstream guide member 81, which is determined from the specifications of the medium M to be used, is equal to or less than a set value, the control unit 51 controls the switching unit 82 to bring the upstream guide member 81 into the fixed state.

Meanwhile, when the coefficient of friction between the medium M and the outer surface of the upstream guide member 81, which is determined from the specifications of the medium M to be used, is larger than the set value, the control unit 51 controls the switching unit 82 to bring the upstream guide member 81 into the rotating state.

The upstream guide roller 83 is disposed at a position between the upstream guide member 81 and the discharge guide frame 29 of the conveyance unit 20 in the conveyance path along which the medium M is conveyed. The upstream guide roller 83 is disposed in the −Z direction of the upstream guide member 81 and the discharge guide frame 29.

The upstream guide roller 83 is a cylindrical roller rotatable about a center axis along the Y axis. The upstream guide roller 83 is supported by the frame 48 so as to be rotatable about the center axis of the upstream guide roller 83.

The medium M passing over the discharge guide frame 29 and yet to be wound on the upstream guide member 81 is wound on the outer surface of the upstream guide roller 83.

The load acting on the upstream guide roller 83 when the medium M is wound thereon is smaller than the load acting on the tension roller 43 when the medium M is wound thereon. Therefore, the outer diameter of the outer surface of the upstream guide roller 83 is set to be smaller than the outer diameter of the outer surface of the tension roller 43.

The medium M is wound on the upstream guide roller 83 in a direction such that the recording surface of the medium M is in contact with the outer surface thereof. The medium M wound on the upstream guide roller 83 is conveyed in an oblique direction having the +X component and the +Z component toward the upstream guide member 81 downstream in the conveyance direction.

The downstream guide roller 84 is disposed at a position between the take-up roller 41 and the intermediate guide member 45 in the conveyance path along which the medium M is conveyed. The downstream guide roller 84 is disposed in the −X direction of the take-up roller 41. The downstream guide roller 84 is disposed in the −Z direction of the intermediate guide member 45.

The downstream guide roller 84 is a cylindrical member formed of a metal material such as aluminum or SUS, and extends along the Y axis. The downstream guide roller 84 is rotatable about a center axis along the Y axis. The medium M passing over the intermediate guide member 45 and yet to be wound up around the take-up roller 41 is wound on the outer surface of the downstream guide roller 84.

The medium M is wound on the downstream guide roller 84 in a direction such that the recording surface of the medium M is in contact with the outer surface thereof. The medium M wound on the downstream guide roller 84 is conveyed toward the outer circumferential surface of the medium roll 70 downstream in the conveyance direction.

The second heating unit 85 heats the downstream guide roller 84. The second heating unit 85 is disposed inside the cylindrical downstream guide roller 84. The second heating unit 85 is a cylindrical heater having a diameter smaller than the inner diameter of the downstream guide roller 84, and extends along the Y axis inside the downstream guide roller 84.

The second heating unit 85 generates heat under the control of the heating unit adjustment unit 47 (see FIG. 2) and heats the downstream guide roller 84. The control unit 51 controls the heating unit adjustment unit 47 and thus adjusts the heating of the downstream guide roller 84 by the second heating unit 85.

The medium M is heated by being wound on the downstream guide roller 84 heated by the second heating unit 85. Since the medium M is heated by the downstream guide roller 84 in addition to being heated by the intermediate guide member 45, wrinkling in the medium M is further suppressed when the medium M is wound up around the take-up roller 41.

The downstream guide roller 84 and the second heating unit 85 are supported by a support part (not shown) of the displacement unit 86 (see FIG. 2) so as to be swingable about the rotation axis of the take-up roller 41. The displacement unit 86 displaces the position of the downstream guide roller 84 in relation to the intermediate guide member 45.

The displacement unit 86 includes a drive source such as a motor, not illustrated, a transmission mechanism that transmits a driving force from the drive source to the support unit, and a control circuit that causes the drive source to operate based on a control signal from the control unit 51.

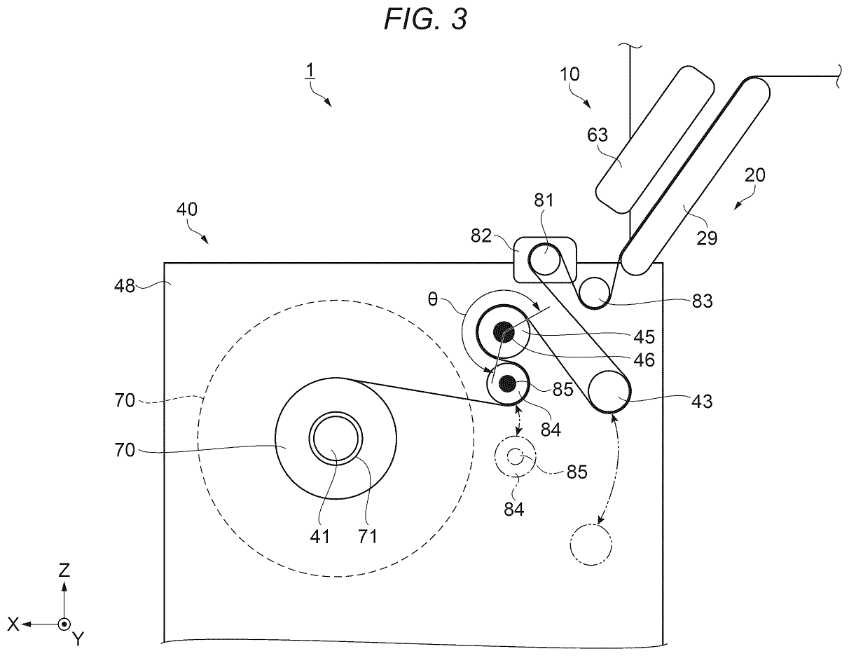

When the displacement unit 86 is driven, the downstream guide roller 84 swings and thus the position of the downstream guide roller 84 in relation to the intermediate guide member 45 changes. When the position of the downstream guide roller 84 in relation to the intermediate guide member 45 changes, a wrap angle θ (see FIG. 3) of the medium M wound on the outer surface of the intermediate guide member 45 changes.

In other words, when the position of the downstream guide roller 84 in relation to the intermediate guide member 45 changes, the amount of winding of the medium M wound on the outer surface of the intermediate guide member 45 changes. When the amount of winding of the medium M wound on the intermediate guide member 45 changes, the magnitude of the tension acting on the medium M wound up around the take-up roller 41 when the medium M is wound up changes.

The control unit 51 controls the displacement unit 86 and thus displaces the tension roller 43. The control unit 51 controls the displacement unit 86 and thus changes the interval between the intermediate guide member 45 and the downstream guide roller 84.

Also, the control unit 51 can adjust the wrap angle θ of the medium M wound on the intermediate guide member 45 by controlling the displacement unit 86. Thus, the magnitude of the tension acting on the medium M wound up around the take-up roller 41 when the medium M is wound up is adjusted.

For example, when the recording device 1 is in a standby mode in which the recording device 1 does not perform recording on the medium M, the control unit 51 positions the downstream guide roller 84 at a standby position shown in FIG. 1. In FIG. 3, the downstream guide roller 84 at the standby position is indicated by a one-dot chain line.

When the recording device 1 is in a recording mode in which the recording device 1 performs recording on the medium M, the control unit 51 positions the downstream guide roller 84 at a recording position indicated by a solid line in FIG. 3. As illustrated in FIG. 3, the downstream guide roller 84 at the recording position is positioned in the +Z direction from the downstream guide roller 84 at the standby position.

The downstream guide roller 84 at the recording position is closer to the intermediate guide member 45 than the downstream guide roller 84 at the standby position. The interval between the downstream guide roller 84 at the standby position and the intermediate guide member 45 is wider than the interval between the downstream guide roller 84 at the recording position and the intermediate guide member 45.

In other words, the control unit 51 sets the interval between the downstream guide roller 84 and the intermediate guide member 45 to be wider when recording is not performed than when recording is performed. Thus, for example, when the recording device 1 is in the standby mode, the operator can easily set the medium M in the take-up device 40. The setting of the medium M to the take-up device 40 includes winding the medium M on the intermediate guide member 45 and the downstream guide roller 84, fixing the medium M to the roll core 71, and the like.

The wrap angle θ of the medium M wound on the outer surface of the intermediate guide member 45 is larger when the downstream guide roller 84 is at the recording position than when the downstream guide roller 84 is at the standby position. The amount of winding of the medium M wound on the intermediate guide member 45 is larger when the downstream guide roller 84 is at the recording position than when the downstream guide roller 84 is at the standby position.

In this case, the magnitude of the tension acting on the medium M wound up around the take-up roller 41 when the medium M is wound up is larger when the downstream guide roller 84 is at the recording position than when the downstream guide roller 84 is at the standby position.

In other words, the control unit 51 causes the wrap angle θ of the medium M wound on the outer surface of the intermediate guide member 45 to be larger when recording is performed than when recording is not performed.

Details of the control unit 50 will now be described. As shown in FIG. 2, the control unit 50 includes the control unit 51, a storage unit 52, an interface unit 53, an operation unit 54, and a notification unit 55. The storage unit 52 and the interface unit 53 are coupled to the control unit 51.

The control unit 51 includes a processor such as a central processing unit (CPU). The control unit 51 operates according to a control program, not shown, that is stored in the storage unit 52 and thus controls various operations of the recording device 1.

The storage unit 52 includes a semiconductor memory such as a read-only memory (ROM) or a random-access memory (RAM), or a storage such as a hard disk drive (HDD) or a solid-state drive (SSD). The storage unit 52 stores various information in addition to the above-described control program.

Each drive unit or the like provided in the recording device 1 is coupled to the interface unit 53. Specifically, the conveyance roller drive unit 28, the recording unit drive unit 61, the carriage drive unit 62, and the drying unit adjustment unit 64 of the device main body 10 are coupled to the interface unit 53.

The supply roller drive unit 32 and the supply bar drive unit 35 of the supply device 30 are coupled to the interface unit 53. Moreover, the take-up roller drive unit 42, the tension roller drive unit 44, the heating unit adjustment unit 47, the switching unit 82, and the displacement unit 86 of the take-up device 40 are coupled to the interface unit 53. The control unit 51 transmits a control signal to each of these elements via the interface unit 53 and thus controls the operation of each element.

Moreover, the operation unit 54 and the notification unit 55 are coupled to the interface unit 53. The operation unit 54 is configured with operation buttons and the like, accepts an input operation performed by an operator, and transmits information corresponding to the input operation to the control unit 51. The operation unit 54 may be configured integrally with the display device of the notification unit 55, like a touch panel.

The notification unit 55 is configured with, for example, a display device such as a liquid crystal display or an organic electroluminescence (EL) display, and gives a notification of information or the like based on the control of the control unit 51, in the form of characters or images.

The notification unit 55 may be configured with a voice generation device instead of the display device. In this case, the notification unit 55 gives a notification of information or the like based on the control of the control unit 51 by voice. The notification unit 55 may be configured with a communication device. In this case, the notification unit 55 transmits information or the like based on the control of the control unit 51 to a terminal device or the like carried by the user.

The control unit 50 is not limited to the configuration provided in the device main body 10 and may be provided in the supply device 30 or the take-up device 40. The control unit 50 may be configured independently of the device main body 10, the supply device 30, and the take-up device 40.

As described above, the recording device 1 according to the embodiment can achieve the following effects.

The recording device 1 includes the conveyance unit 20 conveying the medium M, the recording unit 24 performing recording on the recording surface of the medium M, and the take-up roller 41 winding up the conveyed medium M. The recording device 1 includes the tension roller 43 movably disposed at a position between the conveyance unit 20 and the take-up roller 41 in the conveyance path along which the medium M is conveyed, and applying tension to the medium M by coming into contact with the medium M. The recording device 1 includes the intermediate guide member 45, which is disposed at a position between the take-up roller 41 and the tension roller 43 in the conveyance path and on which the medium M is wound in a direction such that the opposite surface of the recording surface is in contact with the outer surface thereof. The recording device 1 includes the first heating unit 46 heating the intermediate guide member 45. The recording device 1 includes the downstream guide roller 84, which is rotatably disposed at a position between the take-up roller 41 and the intermediate guide member 45 in the conveyance path and on which the medium M is wound in a direction such that the recording surface is in contact with the outer surface thereof.

Thus, since the downstream guide roller 84 is provided, the change in the wrap angle at which the medium is wound on the intermediate guide member 45 can be easily reduced. Therefore, as the variation in the tension applied to the medium M wound up by the winding roller 41 is reduced, the occurrence of winding defects such as winding misalignment in the medium M wound up in a roll shape can be suppressed.

Moreover, since the first heating unit 46 heating the intermediate guide member 45 is provided, the occurrence of winding defects such as wrinkling due to moisture absorption of the medium M in the transport path can be suppressed.

The recording device 1 further includes the second heating unit 85 heating the downstream guide roller 84. Thus, in the medium M wound up in a roll shape, the occurrence of winding defects such as wrinkling due to moisture absorption of the medium M in the transport path from the intermediate guide member 45 toward the winding roller 41 can be suppressed.

The recording device 1 further includes the displacement portion 86 displacing the position of the downstream guide roller 84 in relation to the intermediate guide member 45.

Thus, since the wrap angle at which the medium is wound on the intermediate guide member 45 can be adjusted, tension of an appropriate magnitude can be applied to the medium M wound up by the take-up roller 41. Therefore, the occurrence of winding defects such as winding misalignment in the medium M wound up in a roll shape can be suppressed.

The recording device 1 further includes the control unit 51 that can displace the position of the downstream guide roller 84 by controlling the displacement unit 86. The control unit 51 causes the wrap angle θ of the medium M wound on the outer surface of the intermediate guide member 45 to be larger when recording is performed than when recording is not performed. The control unit 51 sets the interval between the downstream guide roller 84 and the intermediate guide member 45 to be wider when recording is not performed than when recording is performed.

Thus, the occurrence of winding defects in the medium M wound up in a roll shape can be suppressed, and when recording is not performed, the medium M can be easily set on the intermediate guide member 45, the downstream guide roller 84, the take-up roller 41, and the like.

The recording device 1 according to the above embodiment of the present disclosure basically has the configuration as described above, but as a matter of course, modifications, omissions, and the like of a part of the configuration can be made without departing from the spirit and scope of the present disclosure. The above embodiment and other embodiments described below can be combined with each other as long as no technical inconsistencies are involved. Other embodiments will now be described.

In the above embodiment, the switching unit 82 may not include a drive source that displaces the lock member. In this case, the rotating state and the fixed state of the upstream guide member 81 may be switched by the operator operating the lock member of the switching unit 82.

In this case, for example, the lock member may be a fixing screw, and the upstream guide member 81 may be brought into the fixed state by tightening the fixing screw, whereas the upstream guide member 81 may be brought into the rotating state by loosening or removing the fixing screw.

In this case, based on the specifications of the medium M used for recording, the control unit 51 may use the notification unit 55 to give a notification for prompting the operator to switch the upstream guide member 81 between the fixed state and the rotating state.

For example, it is assumed that the operator operates the operation unit 54 to input the type of the medium M used for recording. When the coefficient of friction between the medium M determined by the type of the medium M and the outer surface of the upstream guide member 81 is equal to or less than a set value, the control unit 51 causes the notification unit 55 to notify the operator to bring the upstream guide member 81 into the fixed state.

When the coefficient of friction is larger than the set value, the control unit 51 causes the notification unit 55 to notify the operator to bring the upstream guide member 81 into the rotating state. Based on the notification by the notification unit 55, the operator brings the upstream guide member 81 into the rotating state or the fixed state.

In the above embodiment, as long as the wrap angle θ of the medium M wound on the intermediate guide member 45 can be adjusted, the downstream guide roller 84 may not swing about the rotation axis of the take-up roller 41.

For example, the downstream guide roller 84 and the second heating unit 85 may be supported by the displacement unit 86 so as to be movable in the Z-axis direction. In this case, for example, as in the above embodiment, the downstream guide roller 84 and the second heating unit 85 are disposed on the −Z direction side of the intermediate guide member 45. In this case, as in the above embodiment, the downstream guide roller 84 at the recording position is located in the +Z direction in relation to the downstream guide roller 84 at the standby position.

Alternatively, as long as the wrap angle θ of the medium M wound on the intermediate guide member 45 can be adjusted, the downstream guide roller 84 and the second heating unit 85 may be supported by the displacement unit 86 so as to be movable in the X-axis direction.

In this case, for example, the downstream guide roller 84 and the second heating unit 85 are disposed on the −Z direction side of the intermediate guide member 45. In this case, the downstream guide roller 84 at the recording position is located in the −X direction than the downstream guide roller 84 at the standby position.

In the above embodiment, the take-up device 40 may not include the second heating unit 85 heating the downstream guide roller 84.

In the above embodiment, the downstream guide roller 84 may not be displaced in relation to the intermediate guide member 45 as long as a predetermined angle can be secured as the wrap angle θ of the medium M wound on the intermediate guide member 45. In this case, the downstream guide roller 84 may be rotatably supported by the frame 48. In this case, the take-up device 40 may not include the displacement unit 86.

What is claimed is:

1. A recording device comprising:
a conveyance unit configured to convey a medium;
a recording unit configured to perform recording on a recording surface of the medium;
a take-up unit configured to wind up the conveyed medium;
a tension applying unit movably disposed at a position between the conveyance unit and the take-up unit in a conveyance path along which the medium is conveyed, the tension applying unit being configured to come into contact with the medium and thus apply tension to the medium;
an intermediate guide member that is disposed at a position between the take-up unit and the tension applying unit in the conveyance path and on which the medium is wound in a direction such that a surface opposite to the recording surface is in contact with an outer surface thereof;
a first heating unit configured to heat the intermediate guide member; and
a downstream guide roller that is rotatably disposed at a position between the take-up unit and the intermediate guide member in the conveyance path and on which the medium is wound in a direction such that the recording surface is in contact with an outer surface thereof.

2. The recording device according to claim 1, further comprising:
a second heating unit configured to heat the downstream guide roller.

3. The recording device according to claim 1, further comprising:
a displacement unit configured to displace a position of the downstream guide roller in relation to the intermediate guide member.

4. The recording device according to claim 3, further comprising:
a control unit configured to be able to displace the position of the downstream guide roller by controlling the displacement unit, wherein
the control unit
sets a wrap angle of the medium wound on the outer surface of the intermediate guide member to be larger when the recording is performed than when the recording is not performed, and
sets an interval between the downstream guide roller and the intermediate guide member to be larger when the recording is not performed than when the recording is performed.
